(19) United States
(12) Patent Application Publication
(10) Pub. No.: US 2026/0368969 A1
(43) Pub. Date: Nov. 19, 2026

(54) SYSTEM AND METHOD FOR IMAGE GENERATION

(71) Applicant: Samsung Electronics Co., Ltd., Suwon-si (KR)

(72) Inventors: Xingyi LI, San Diego, CA (US); Yangwen LIANG, San Diego, CA (US); Kee-Bong SONG, San Diego, CA (US); Donghoon KIM, Gyeonggi-do (KR)

(21) Appl. No.: 19/672,491

(22) Filed: May 8, 2026

Related U.S. Application Data
(60) Provisional application No. 63/803,442, filed on May 9, 2025.

(51) Int. Cl. G06T 11/60; G06T 15/00; G06V 10/778

(52) U.S. Cl. CPC G06T 11/60; G06T 15/00; G06V 10/778

(57) ABSTRACT

A system and a method are disclosed for image generation. In some embodiments, a method includes: rendering a pixel of an image corresponding to a camera pose, the rendering including: calculating a contribution from a first scene element, the contribution being based on: an opacity function of the first scene element; a color of the first scene element; a transmittance of a second scene element; and a first attention coefficient, the first attention coefficient being based on a first measure of similarity between attributes of the first scene element and attributes of the pixel.

### CROSS-REFERENCE TO RELATED APPLICATION

This application claims the priority benefit under 35 U.S.C. § 119(e) of U.S. Provisional Application No. 63/803,442, filed on May 9, 2025, the disclosure of which is incorporated by reference in its entirety as if fully set forth herein.

### TECHNICAL FIELD

The disclosure generally relates to image generation. More particularly, the subject matter disclosed herein relates to improvements to a system and method for generating a three-dimensional model and rendering images based on the three-dimensional model.

### SUMMARY

In various applications, it may be useful to have the capability to generate images corresponding to views, from different directions, of a three-dimensional scene. This may be challenging when only a set of images, taken from a set of viewing angles, are available, and images from other viewing angles, not included the set of viewing angles, are needed.

To solve this problem, a three-dimensional model of the scene may be constructed. Such a three-dimensional model may include a plurality of small scene elements, contributing to a generated image according to a rendering function, which generates images based on the three-dimensional model and on the position and viewing direction of a camera.

One issue with the above approach is that the generated images may have imperfections, such as rendering inconsistencies, artifacts, and degraded image quality.

To overcome these issues, systems and methods are described herein for using an attention term in the rendering function. This attention term may be calculated based on a measure of similarity between the scene elements and the pixels of the camera. The attention term may reduce the weight accorded to scene elements which contribute to rendering inconsistencies, artifacts, and degraded image quality, and increase the weight accorded to scene elements that contribute to high image quality.

The above approaches improve on previous methods because it improves the quality of the generated images.

According to an embodiment of the present disclosure, there is provided a method, including: rendering a pixel of an image corresponding to a camera pose, the rendering including: calculating a contribution from a first scene element, the contribution being based on: an opacity function of the first scene element; a color of the first scene element; a transmittance of a second scene element; and a first attention coefficient, the first attention coefficient being based on a first measure of similarity between attributes of the first scene element and attributes of the pixel.

In some embodiments, the first measure of similarity is normalized such that a sum of the first measure of similarity and measures of similarity of a plurality of scene elements, not including the first scene element, is equal to a constant.

In some embodiments, the first measure of similarity is within 30% of a similarity function, the similarity function being proportional to a dot product of a first vector and a second vector, the first vector being based on the attributes of the first scene element, and the second vector being based on the attributes of the pixel.

In some embodiments, the first vector is equal to a kernel function evaluated on a product of a matrix and the attributes of the first scene element, the kernel function being a differentiable nonlinear monotonically increasing function that is bounded below.

In some embodiments, the first measure of similarity is calculated based on a linear transformation of the attributes of the pixel.

In some embodiments, the linear transformation maps a 9-dimensional vector including the attributes of the pixel to a vector having more than 9 dimensions.

In some embodiments, the first measure of similarity is calculated based on a linear transformation of the attributes of the first scene element.

In some embodiments, the linear transformation maps a 9-dimensional vector including the attributes of the first scene element to a vector having more than 9 dimensions.

In some embodiments, the attributes of the first scene element include coordinates of the first scene element.

In some embodiments, the attributes of the first scene element further include scale factors for the first scene element.

In some embodiments, the attributes of the first scene element further include a rotation for the first scene element.

In some embodiments, the method further includes performing supervised training to determine the attributes of the first scene element.

In some embodiments: the first measure of similarity is calculated based on a linear transformation of the attributes of the first scene element, and the method further includes performing supervised training to determine parameters of the linear transformation.

According to an embodiment of the present disclosure, there is provided a system including: one or more processors; and a memory storing instructions which, when executed by the one or more processors, cause performance of: rendering a pixel of an image corresponding to a camera pose, the rendering including: calculating a contribution from a first scene element, the contribution being based on: an opacity function of the first scene element; a color of the first scene element; a transmittance of a second scene element; and a first attention coefficient, the first attention coefficient being based on a first measure of similarity between attributes of the first scene element and attributes of the pixel.

In some embodiments, the first measure of similarity is normalized such that a sum of the first measure of similarity and measures of similarity of a plurality of scene elements, not including the first scene element, is equal to a constant.

In some embodiments, the first measure of similarity is within 30% of a similarity function, the similarity function being proportional to a dot product of a first vector and a second vector, the first vector being based on the attributes of the first scene element, and the second vector being based on the attributes of the pixel.

In some embodiments, the first vector is equal to a kernel function evaluated on a product of a matrix and the attributes of the first scene element, the kernel function being a differentiable nonlinear monotonically increasing function that is bounded below.

In some embodiments, the first measure of similarity is calculated based on a linear transformation of the attributes of the pixel.

In some embodiments, the linear transformation maps a 9-dimensional vector including the attributes of the pixel to a vector having more than 9 dimensions.

According to an embodiment of the present disclosure, there is provided a system including: means for processing; and a memory storing instructions which, when executed by the means for processing, cause performance of: rendering a pixel of an image corresponding to a camera pose, the rendering including: calculating a contribution from a first scene element, the contribution being based on: an opacity function of the first scene element; a color of the first scene element; a transmittance of a second scene element; and a first attention coefficient, the first attention coefficient being based on a first measure of similarity between attributes of the first scene element and attributes of the pixel.

### BRIEF DESCRIPTION OF THE DRAWINGS

In the following section, the aspects of the subject matter disclosed herein will be described with reference to exemplary embodiments illustrated in the figures, in which:

FIG. 1A is a schematic drawing of a system and method for capturing training images of a three-dimensional scene, according to an embodiment.

FIG. 1B is a schematic drawing of a system for capturing training images of a three-dimensional scene, according to an embodiment.

FIG. 1C is a block diagram of a system for training and inference, according to an embodiment.

FIG. 2 is an illustration of a plurality of Gaussian ellipses in a tile, according to an embodiment.

FIG. 3 is a schematic drawing of Gaussian ellipses in a scene model, according to an embodiment.

FIG. 4 is a flowchart of a method for generating images, according to an embodiment.

FIG. 5 is a block diagram of an electronic device in a network environment, according to an embodiment.

### DETAILED DESCRIPTION

In the following detailed description, numerous specific details are set forth in order to provide a thorough understanding of the disclosure. It will be understood, however, by those skilled in the art that the disclosed aspects may be practiced without these specific details. In other instances, well-known methods, procedures, components and circuits have not been described in detail to not obscure the subject matter disclosed herein.

Reference throughout this specification to “one embodiment” or “an embodiment” means that a particular feature, structure, or characteristic described in connection with the embodiment may be included in at least one embodiment disclosed herein. Thus, the appearances of the phrases “in one embodiment” or “in an embodiment” or “according to one embodiment” (or other phrases having similar import) in various places throughout this specification may not necessarily all be referring to the same embodiment. Furthermore, the particular features, structures or characteristics may be combined in any suitable manner in one or more embodiments. In this regard, as used herein, the word “exemplary” means “serving as an example, instance, or illustration.” Any embodiment described herein as “exemplary” is not to be construed as necessarily preferred or advantageous over other embodiments. Additionally, the particular features, structures, or characteristics may be combined in any suitable manner in one or more embodiments. Also, depending on the context of discussion herein, a singular term may include the corresponding plural forms and a plural term may include the corresponding singular form. Similarly, a hyphenated term (e.g., “two-dimensional,” “pre-determined,” “pixel-specific,” etc.) may be occasionally interchangeably used with a corresponding non-hyphenated version (e.g., “two dimensional,” “predetermined,” “pixel specific,” etc.), and a capitalized entry (e.g., “Counter Clock,” “Row Select,” “PIXOUT,” etc.) may be interchangeably used with a corresponding non-capitalized version (e.g., “counter clock,” “row select,” “pixout,” etc.). Such occasional interchangeable uses shall not be considered inconsistent with each other.

Also, depending on the context of discussion herein, a singular term may include the corresponding plural forms and a plural term may include the corresponding singular form. It is further noted that various figures (including component diagrams) shown and discussed herein are for illustrative purpose only, and are not drawn to scale. For example, the dimensions of some of the elements may be exaggerated relative to other elements for clarity. Further, if considered appropriate, reference numerals have been repeated among the figures to indicate corresponding and/or analogous elements.

The terminology used herein is for the purpose of describing some example embodiments only and is not intended to be limiting of the claimed subject matter. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that when an element or layer is referred to as being on, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

The terms “first,” “second,” etc., as used herein, are used as labels for nouns that they precede, and do not imply any type of ordering (e.g., spatial, temporal, logical, etc.) unless explicitly defined as such. Furthermore, the same reference numerals may be used across two or more figures to refer to parts, components, blocks, circuits, units, or modules having the same or similar functionality. Such usage is, however, for simplicity of illustration and ease of discussion only; it does not imply that the construction or architectural details of such components or units are the same across all embodiments or such commonly-referenced parts/modules are the only way to implement some of the example embodiments disclosed herein.

Unless otherwise defined, all terms (including technical and scientific terms) used herein have the same meaning as commonly understood by one of ordinary skill in the art to which this subject matter belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As used herein, the term “module” refers to any combination of software, firmware and/or hardware configured to provide the functionality described herein in connection with a module. For example, software may be embodied as a software package, code and/or instruction set or instructions, and the term “hardware,” as used in any implementation described herein, may include, for example, singly or in any combination, an assembly, hardwired circuitry, programmable circuitry, state machine circuitry, and/or firmware that stores instructions executed by programmable circuitry. The modules may, collectively or individually, be embodied as circuitry that forms part of a larger system, for example, but not limited to, an integrated circuit (IC), system on-a-chip (SoC), an assembly, and so forth.

Each of the terms “processing circuit” and “means for processing” is used herein to mean any combination of hardware, firmware, and software, employed to process data or digital signals. Processing circuit hardware may include, for example, application specific integrated circuits (ASICs), general purpose or special purpose central processing units (CPUs), digital signal processors (DSPs), graphics processing units (GPUs), and programmable logic devices such as field programmable gate arrays (FPGAs). In a processing circuit, as used herein, each function is performed either by hardware configured, i.e., hard-wired, to perform that function, or by more general-purpose hardware, such as a CPU, configured to execute instructions stored in a non-transitory storage medium. A processing circuit may be fabricated on a single printed circuit board (PCB) or distributed over several interconnected PCBs. A processing circuit may contain other processing circuits; for example, a processing circuit may include two processing circuits, an FPGA and a CPU, interconnected on a PCB.

As used herein, when a method (e.g., an adjustment) or a first quantity (e.g., a first variable) is referred to as being “based on” a second quantity (e.g., a second variable) it means that the second quantity is an input to the method or influences the first quantity, e.g., the second quantity may be an input (e.g., the only input, or one of several inputs) to a function that calculates the first quantity, or the first quantity may be equal to the second quantity, or the first quantity may be the same as (e.g., stored at the same location or locations in memory as) the second quantity.

Aspects of some embodiments of the present disclosure relate to techniques for generating images of a three-dimensional scene using a collection of scene elements that approximate portions of the scene. Each scene element may represent a small region of the scene and may contribute light to pixels of a rendered image. In some implementations, the scene elements may be represented using Gaussian ellipsoids that are projected onto an image plane during rendering. Such a method may be referred to as “Gaussian splatting”.

In some systems, rendering techniques may determine the contribution of each scene element largely independently from other scene elements. However, this approach may produce visual artifacts or reduced image quality in scenes containing complex geometry, occlusion, or view-dependent effects.

To address these issues, some embodiments described herein determine the contribution of each scene element based not only on its own attributes, but also on contextual relationships between scene elements and the pixels being rendered. For example, similarity measures may be calculated between attributes of a scene element and attributes of a pixel, and these similarity measures may be used to determine attention values that weight the contribution of the scene element when computing the color of the pixel. By incorporating such attention-based weighting into the rendering process, the system may more accurately represent relationships among scene elements and may produce higher-quality rendered images.

Some rendering techniques and systems that use Gaussian splatting may determine the contribution of each Gaussian ellipsoid independently. This can result in visual artifacts, inconsistent shading, and reduced rendering quality in scenes containing complex geometry or occlusions. Embodiments according to the present disclosure may modify the rendering pipeline itself by introducing attention-based weighting that dynamically adjusts the contribution of Gaussian ellipsoids based on contextual relationships between scene elements and pixels. As a result, the rendering process produces relatively improved visual fidelity while maintaining efficient rendering performance.

For example, in various applications, including augmented reality, virtual reality, game development, and medical imaging, it may be useful to generate two-dimensional camera views from a three-dimensional (3D) model of a scene. For example, a three-dimensional model of a building may be used, in an augmented reality or virtual reality application, to generate the two-dimensional image of the building that a camera at an arbitrary position outside of the building would capture. Such an image may be referred to as a two-dimensional image of the scene; the “scene” may be the three-dimensional object (e.g., the building) and its surroundings, two-dimensional images of which are obtained.

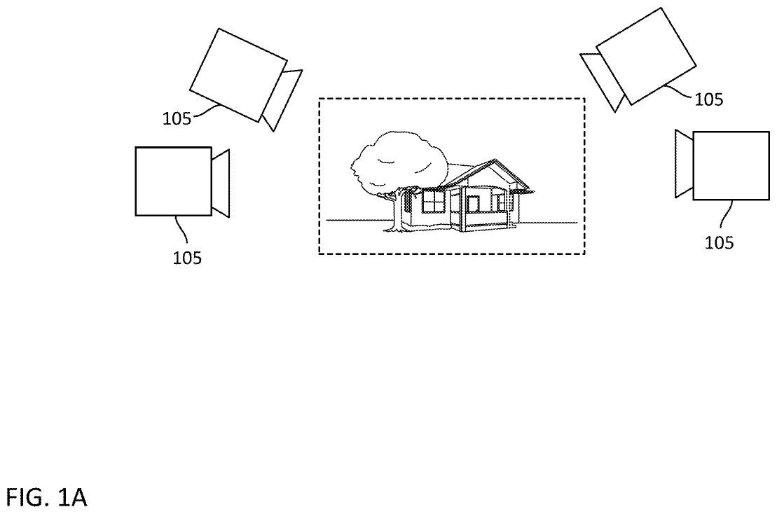

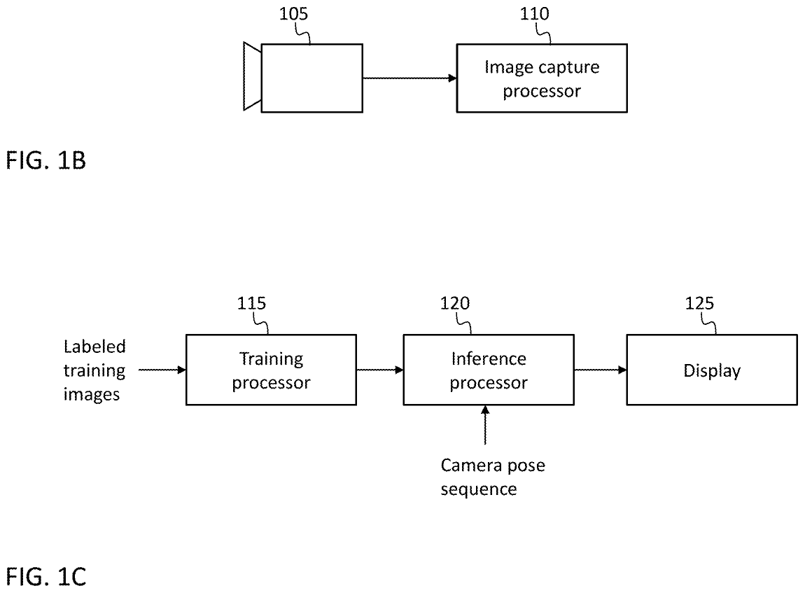

The two-dimensional image obtained by a camera capturing images (e.g., a stream of images forming video data) may depend on both the position of the camera and the direction in which the camera is aimed. This combination of position and direction of view may be referred to herein as the “pose” of the camera, or the “camera pose”. FIG. 1A shows a physical camera 105 being used to capture images (which may be referred to as “captured images” or “training images”) from a variety of camera poses. Such training images may be used to generate a three-dimensional model of the scene, or “scene model”, from which two-dimensional images (or “generated” images) may then be produced, for camera poses other than those from which the training images were captured.

FIG. 1B shows a system that may be used to capture training images. A camera 105 (which may include a lens and an image sensor) receives light from the scene. The light is projected, by the lens of the camera 105, onto the image sensor of the camera 105. The light is detected by the image sensor, converted into an electronic representation, and stored by the image capture processor 110.

The generating of a two-dimensional image based on a three-dimensional model of a scene and based on a camera pose may be referred to as two-dimensional rendering, or simply “rendering”. Techniques for performing two-dimensional rendering may be computationally intensive. As such, a system for image generation (which may include a scene model and a system and method for performing two-dimensional rendering using the scene model) may be designed to balance the quality of the two-dimensional images produced and the speed at which each such image is produced. Rendering an image may include (e.g., consist of) rendering each pixel of the image.

In some embodiments, for example, the three-dimensional scene may be modeled as a collection, or “point cloud” of scene elements, each of which occupies a small volume in the scene model and emits light toward the camera. In such a model, each scene element may be modeled as an emitter (e.g., not as a reflector) of light. Supervised training (using a training processor 115, as illustrated in FIG. 1C) may be used to create the scene model and to adjust any parameters (discussed in further detail below) of the method for rendering. The supervised training may be performed using a plurality of labeled training images, each labeled with the camera pose at which it was taken. Each iteration of training may include (i) generating, using the system for image generation, a plurality of generated images, each corresponding to a respective training image (ii) calculating a loss function that is a measure of the discrepancies between the generated images and the training images, and (iii) adjusting, using backpropagation, the parameters of the system for image generation in a direction that reduces the loss function. Once training has been completed, the parameters obtained by the training may be transferred to an inference processor 120, which may perform inference (e.g., rendering) using the parameters, and using one or more camera poses for which images are to be rendered. For example, the camera poses may be part of a sequence of camera poses that, when used for rendering, produce a video stream which may be sent to a display 125 (e.g., an augmented reality or virtual reality display) for viewing by a user. Each of the processors of FIGS. 1B and 1C may be a processing circuit (discussed in further detail above).

Each scene element may or may not be visible to the camera. A first scene element may not be visible to the camera if, for example, one or more other scene elements (which may be referred to as “obstructions”) are present between the first scene element and the camera, blocking the camera's view of the first scene element.

The effect of the camera may be to receive light from all of the scene elements visible to the camera, and to generate a two-dimensional image by projecting each of the scene elements visible to the camera on to a plane (which may be referred to as the “image plane”), which may correspond to the plane of an image sensor of the camera. The projecting may be performed by a lens, which, in one embodiment, is a pinhole lens. The pinhole lens may project each point in the three-dimensional scene that is visible to the camera onto a location, on the plane, that is at the intersection of (i) a ray, from the point in the three-dimensional scene, that extends through the lens of the camera and (ii) the image plane of the camera.

In some embodiments, each of the scene elements that form the three-dimensional model of the scene is a Gaussian ellipsoid. Each scene element is represented as a Gaussian ellipsoid, modeled as a three-dimensional Gaussian function. The ellipsoid has an anisotropic shape and associated color, which may depend on the viewing direction. When projected onto the image plane, each 3D Gaussian produces a 2D Gaussian footprint.

Each Gaussian ellipsoid, when projected onto the image plane in the absence of obstructions may form, on the image plane, a Gaussian ellipse having a density proportional to a Gaussian function G (e.g., Gᵢ(x) for the i^{th} Gaussian ellipsoid). The Gaussian function of the Gaussian ellipses thus describes how the intensity (or weight) of the ellipse is distributed across the image plane, with the highest value at the center and values that decrease as the distance from the center increases. The Gaussian function, Gᵢ(x), of a Gaussian ellipse may be represented or calculated by the following equation (Equation 1).

$${G}_{i} ( x ) = exp ( - \frac{1}{2} ( x - {μ}_{i} ) {\sum }^{- 1} ( x - {μ}_{i} ) ) \qquad ( 1 )$$

where x is the (vector) position of a point on the image plane, μᵢ is the (vector) position, on the image plane, of the center of the Gaussian ellipse, and Σ⁻¹ is a matrix that determines the size of the Gaussian ellipse and the orientation of its major axis.

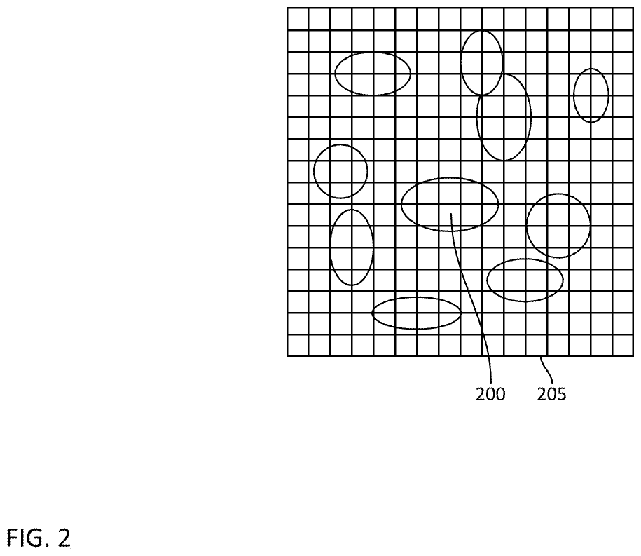

FIG. 2 shows such Gaussian ellipses 200, in one example.

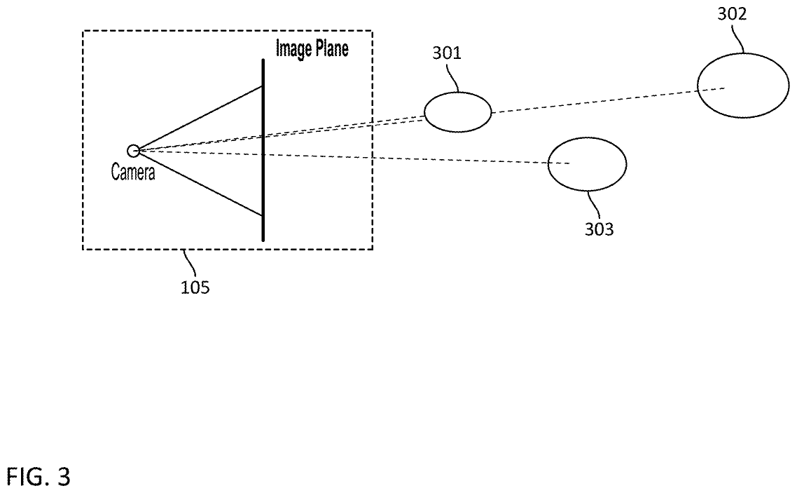

The Gaussian function Gᵢ(x) determines both the radiant intensity of the Gaussian ellipsoid at the camera (the extent to which the Gaussian ellipsoid emits light toward the camera), and the opacity of the Gaussian ellipsoid (the extent to which the Gaussian ellipsoid blocks light emitted by a second Gaussian ellipsoid when the Gaussian ellipsoid is between the second Gaussian ellipsoid and the camera). This is illustrated in FIG. 3, which shows a first Gaussian ellipsoid 301, emitting light toward the camera 105, a second Gaussian ellipsoid 302, the light from which is blocked, or partially blocked, by the first Gaussian ellipsoid 301, and a third Gaussian ellipsoid 303 the light from which is not blocked. The two-dimensional projected Gaussian determines the point-wise opacity function σᵢ(x) through the relation:

σᵢ(x)=αᵢGᵢ(x) (2)

where αᵢ is the learned opacity value of the i^{th} Gaussian ellipsoid, and x is a vector specifying a position (e.g., the position of a pixel being rendered) on the image plane. The opacity function indicates how strongly a Gaussian ellipsoid blocks light at a particular location in the image plane. Higher opacity values correspond to the ellipsoid blocking more light from objects behind it, while lower values correspond to the ellipsoid being more transparent.

The transmittance Tᵢ(x) along the ray extending from the i^{th} Gaussian ellipsoid to the position x on the image plane may be influenced by other Gaussian ellipsoids that are between the i^{th} Gaussian ellipsoid and the position x on the (2D) image plane:

$${T}_{i} ( x ) = {\prod }_{j = 1}^{i - 1} ( 1 - {σ}_{j} ( x ) ) for i > 1 , and {T}_{1} = 1. \qquad ( 2 )$$

In Equation 3, the Gaussian ellipsoids may be sorted (e.g., their indices may be selected) so that if the j^{th} Gaussian ellipsoid is closer to the camera than the i^{th} Gaussian ellipsoid, then j<i. The transmittance Tᵢ(x) represents how much of the light from the Gaussian ellipsoid reaches the image plane after accounting for any blocking by other Gaussian ellipsoids located between the ellipsoid and the camera. Gaussian ellipsoids that are closer to the camera may partially reduce or block the light from ellipsoids that are farther away.

As indicated by the transmittance expression Tᵢ(x), in a method for two-dimensional rendering according to some embodiments, the extent to which light from the i^{th} Gaussian ellipsoid is transmitted to the image plane is proportional to (1−σⱼ(x)), where σⱼ(x) is the opacity function of the j^{th} Gaussian ellipsoid. As such, the greater the opacity of a j^{th} Gaussian ellipsoid (that is between the i^{th} Gaussian ellipsoid and the position x on the image plane), the greater the extent to which the j^{th} Gaussian ellipsoid blocks the light from the i^{th} Gaussian ellipsoid.

In some embodiments, the calculation of the light that reaches the image plane from the i^{th} Gaussian ellipsoid does not take all of the other Gaussian ellipsoids in the three-dimensional scene into account. Instead, the image plane may be divided into a plurality of tiles, each of which may have a size, for example, of sixteen by sixteen pixels (although embodiments according to the present disclosure are not limited thereto, and the size of the tiles may be different according to different embodiments). Such a tile 205 is shown in FIG. 2, along with a plurality of Gaussian ellipses 200 that overlap the tile 205. Two-dimensional rendering may then be performed one tile at a time, taking into account only Gaussian ellipsoids, which are referred to herein as “relevant” Gaussian ellipsoids, that contribute significantly to the portion of the generated image that is within the tile 205. The set of relevant Gaussian ellipsoids may be defined as the set Gaussian ellipsoids for which the truncated Gaussian projection onto the image plane overlaps the tile 205, where the “truncated” Gaussian projection is the Gaussian ellipse 200 that results from projection of the Gaussian ellipsoid onto the image plane, truncated so that only points within the Gaussian ellipse 200 having a value exceeding a certain threshold (e.g., a threshold between 0.1% and 30.0% of the value at the center of the Gaussian ellipse 200) are preserved, and all other points are discarded (e.g., set to zero). In some embodiments, each two-dimensional Gaussian is truncated at its 99% confidence interval, effectively bounding its spatial influence to a finite radius. This process may be used to eliminate a number of Gaussian ellipsoids (e.g., most of the Gaussian ellipsoids) from the rendering calculation.

In some embodiments, contextual relationships among Gaussian ellipsoids associated with a tile of the image plane may be considered when determining the relative contribution of each Gaussian ellipsoid to a rendered pixel. For example, feature vectors associated with Gaussian ellipsoids whose projections overlap a tile may be used in similarity calculations with feature vectors associated with pixels within the tile. The results of these calculations may then be used to determine weighting values that influence the contribution of each Gaussian ellipsoid during rendering of pixels within the tile. A feature vector may be understood as a numerical representation of the attributes of an object. In the present context, the feature vector of a Gaussian ellipsoid represents properties such as its position, scale, and orientation.

The light C(x) that reaches the point x on the image plane may then be calculated using the following equation:

C(x)= [symbol] Tᵢ(x)·σᵢ(x)·cᵢ (4)

where cᵢ is the radiant intensity of the light emitted, in the direction of the camera, by the i^{th} Gaussian ellipsoid, and [symbol] (x) is the set of relevant Gaussian ellipsoids. The color cᵢ may be a vector, with each element of the vector being equal to the radiant intensity at a respective color, with the colors being, for example, red, green, and blue. Similarly, the light may be a vector including an element for each color. Thus, the light C(x) represented according to Equation 4 defines the color or light intensity at a particular point on the image plane by combining the contributions of the Gaussian ellipsoids that influence that location. Each Gaussian ellipsoid contributes light based on its color, its opacity at that location, and the extent to which light from that ellipsoid is able to pass through other ellipsoids that may lie between it and the camera. The contributions of the relevant Gaussian ellipsoids are then combined to produce the final light value at the pixel being rendered.

In some embodiments, a reduction in rendering inconsistencies, artifacts, and degraded image quality may be accomplished by modifying Equation 4 to include an attention term, or “attention value” or “attention coefficient” (discussed in further detail below) that adjusts the contribution of each Gaussian ellipsoid, for example, based on contextual relationships between the Gaussian ellipsoid and the pixel being rendered. The attention term may be calculated using feature vectors representing attributes of the Gaussian ellipsoids and the pixels.

For each Gaussian ellipsoid, a feature vector may be defined as follows, according to Equation 5, based on attributes of the Gaussian ellipsoid:

$$θ = [ {θ}_{x} , {θ}_{y} , {θ}_{z} , {θ}_{roll} , {θ}_{pitch} , {θ}_{yaw} , \frac{{θ}_{sx}}{( {θ}_{sx} + {θ}_{sy} + {θ}_{sz} )} , \frac{{θ}_{sy}}{( {θ}_{sx} + {θ}_{sy} + {θ}_{sz} )} , \frac{{θ}_{sz}}{( {θ}_{sx} + {θ}_{sy} + {θ}_{sz} )} ] \qquad ( 5 )$$

where:

θₓ, θ_{y}, θ_{z} are the coordinates of the center of the Gaussian ellipsoid (in the local frame of the camera),

$$\frac{{θ}_{sx}}{( {θ}_{sx} + {θ}_{sy} + {θ}_{sz} )} , \frac{{θ}_{sy}}{( {θ}_{sx} + {θ}_{sy} + {θ}_{sz} )} , \frac{{θ}_{sz}}{( {θ}_{sx} + {θ}_{sy} + {θ}_{sz} )}$$

are scale factors along the x, y, and z axes (the symbol x is used herein to denote, as context indicates, either (i) a position in the image plane or (ii) a direction parallel to the x axis), and

θᵣₒₗₗ, θ_{pitch}, θ_{yaw} are Euler angles defining a rotation performed, with the Gaussian ellipsoid, after it has been scaled according to the scale factors. Each scale factor represents the extent by which the size of the Gaussian ellipsoid is increased (if the scale factor is greater than 1) or decreased (if the scale factor is less than 1) along the direction to which the scale factor applies

$$( with \frac{{θ}_{sx}}{( {θ}_{sx} + {θ}_{sy} + {θ}_{sz} )} ,$$

for example, being the extent to which the size of the Gaussian ellipsoid is increased or decreased along the x direction).

This set of attributes may represent a subset of the attributes of a Gaussian ellipsoid, which may for example have additional attributes not captured by the feature vector, such as the color of the Gaussian ellipsoid.

Thus, Equation 5 defines a feature vector that represents characteristics of a Gaussian ellipsoid. The feature vector includes attributes such as the position of the ellipsoid in the scene, its size or scale along different directions, and its orientation. These attributes provide a numerical representation of the Gaussian ellipsoid that may be used when comparing the ellipsoid with other elements, such as pixels being rendered.

A similar feature vector, also having 9 elements, may then be defined to generalize each two-dimensional pixel of the camera to a generalized three-dimensional (e.g., spherical) pixel. Such a feature vector may be referred to as a “pixel feature vector”. The first three elements of the pixel feature vector, θₓ, θ_{y}, θ_{z}, may be set to be equal, respectively, to (i) the x-coordinate of the pixel (in the local frame of the camera), (ii) the y-coordinate of the pixel (in a coordinate system attached to the image plane) and (iii) the distance from the camera center to the image plane. The fourth, fifth, and sixth elements of the pixel feature vector may be set to be equal to a rotation that transforms a camera orientation aligned to the coordinate axes of the scene to the camera orientation of the pose for which an image is being generated. The seventh, eighth, and ninth elements of the pixel feature vector may each be set to ⅓.

A measure of similarity s(x)ᵢ between the pixel at location x in the image plane and the i^{th} Gaussian ellipsoid may then be calculated as follows:

$${s ( x )}_{i} = \frac{{φ ( k ( {θ}_{i} ) )}^{T} φ ( q ( {θ}_{x} ) )}{{\sum }_{{θ}_{j} ∈ Θ} {φ ( k ( {θ}_{j} ) )}^{T} φ ( q ( {θ}_{x} ) )} \qquad ( 6 )$$

where θ₁ and θₓ are the feature vector of the Gaussian ellipsoid and of the generalized three-dimensional pixel, respectively, k and q are pointwise feature transformations, and φ is a function that is applied to each element of the vector that is the argument of φ. For example, each of k and q may be a linear transformation (e.g., each may be an m×9 matrix (e.g., a 16×9 matrix) that is multiplied by the respective argument θᵢ and θₓ, although embodiments according to the present disclosure are not limited to the sizes of matrices specifically mentioned herein), or a nonlinear function such as (i) the product formed when a positive semidefinite matrix is pre- and post-multiplied by the vector argument (e.g.,

$$k ( {θ}_{i} ) = {θ}_{i}^{T} k {θ}_{i}$$

for a positive semidefinite matrix k) or (ii) a multi-layer perceptron (MLP). In an embodiment in which k and q is a linear transformation, the size m of the m×9 matrix representing the transformation may be chosen as a balance between improved performance (for larger m) and higher computational burden (for larger m). In some embodiments, the similarity calculation and the attention mechanism described herein may be implemented using a linear attention formulation. For example, feature transformations applied to the Gaussian feature vectors and the pixel feature vectors may be selected such that the computational complexity of determining attention values scales approximately linearly with the number of Gaussian ellipsoids associated with a tile or region of the image plane. Such a formulation may enable efficient rendering of scenes represented by large numbers of Gaussian ellipsoids while preserving the contextual relationships captured by the attention mechanism.

Thus, Equation 6 may be utilized to calculate a similarity value that indicates how closely the attributes of a Gaussian ellipsoid correspond to the attributes of the pixel being rendered. The attributes of the Gaussian ellipsoid and the pixel are first transformed using learnable functions, and the transformed values are then compared to produce the similarity measure. A higher similarity value indicates that the Gaussian ellipsoid is more relevant to the pixel, while a lower similarity value indicates that the ellipsoid is less relevant.

The function φ may be a kernel function, such as an exponential linear unit plus one (ELU+1) function (with an a parameter of the ELU function being 1), a polynomial kernel, or a radial basis function kernel. The ELU+1 may be defined by:

$$φ ( x ) = \{ \begin{matrix}x + 1 , x > 0 \\ α ( {e}^{x} - 1 ) + 1 , x \leq 0\end{matrix} \qquad ( 7 )$$

Thus, Equation 7 defines an example of a kernel function that may be applied to the transformed feature vectors in the calculation (performed in Equation 6) of the similarity values described above. The kernel function transforms the transformed feature vectors in a nonlinear manner so that they can be used to determine attention values that weight the contributions of Gaussian ellipsoids during rendering. This transformation may help stabilize the computation and improve the ability of the system to learn useful weighting relationships.

In some embodiments, the kernel function V is a function that measures similarity or influence between two inputs, and it may be used to weight contributions based on distance or feature similarity. Examples of kernel functions may include, in addition to the ones identified above, the polynomial kernel, the exponential kernel, or the radial basis function (RBF) kernel.

An attention function ξ(x)ᵢ may then be calculated, based on the similarity function, as follows:

ξ(x)ᵢ=exp(s(x)ᵢ)−1,ξ(x)∈[0,e−1] (8)

Thus, Equation 8 calculates an attention value based on the similarity between the attributes of a Gaussian ellipsoid and the attributes of the pixel being rendered. This attention value represents how strongly the Gaussian ellipsoid should influence the color or intensity of the pixel. Gaussian ellipsoids with higher attention values may contribute more strongly to the rendered pixel, while those with lower attention values may contribute less.

The similarity calculation of Equation 6 may be understood as measuring how well the attributes of the Gaussian ellipsoid align with the attributes of the pixel being rendered. The attention function of Equation 8 has the characteristics that (i) it is nonlinear, (ii) it is bounded above and below (as shown above), and (iii) the magnitude of the lower bound is much less than the upper bound (e.g., 0 is much less than e−1). In some embodiments, a different attention function with these characteristics (e.g., ξ(x)ᵢ=x^{a} with 0<a<1) is used.

As mentioned above, the attention function may be added as a term to the rendering function. This may result in the following rendering function:

C(x)= [symbol] Tᵢ(x)·σᵢ(x)·ξ(x)ᵢ·cᵢ (9)

The output of the attention function may be referred to herein as an attention coefficient (or attention weight, or attention value) and represents a value that modulates the contribution of a Gaussian ellipsoid to the rendered pixel. In some embodiments, the calculation of the attention coefficient may be performed by an attention module that receives feature vectors corresponding to a plurality of Gaussian ellipsoids associated with a region of the image plane and feature vectors corresponding to one or more pixels within the region. The attention module may generate attention coefficients that modulate the contribution of each Gaussian ellipsoid to the rendered pixel value. The attention module may operate as part of a rendering pipeline (e.g., executed by an inference processor) in which Gaussian ellipsoids are first projected to the image plane, after which attention coefficients are computed and applied prior to compositing the Gaussian contributions.

This rendering function may avoid various image defects (e.g., rendering inconsistencies, artifacts, and degraded image quality) that may be present if the rendering function of Equation 4 is used.

Training of the system for image generation, which may involve generating the three-dimensional model and training the parameter of the rendering function, may be performed as follows, using labeled training data. The labeled training data may include a plurality of training images taken of the three-dimensional scene, each image being labeled with the camera pose with which the image was obtained. An initial point cloud may be obtained using a structure from motion (SfM) method. Points may be added to this point cloud with each iteration of training (e.g., by adding new points when a gradient for the position of an existing point (e.g., an existing Gaussian ellipsoid) exceeds a threshold) or pruned (e.g., when a region of the three-dimensional model contains a high density of nearly identical Gaussian ellipsoids).

During each iteration of training an image may be generated for each camera pose present in the training data, and the total loss may be calculated using the following loss function to quantify the discrepancy between each generated image and the corresponding training image:

[symbol]

_{Gaussian}(Iₚₕₒₜₒ,I_{render})=(1−λ) [symbol] ₁(Iₚₕₒₜₒ,I_{render})+λ [symbol] _{D-SSIM}(Iₚₕₒₜₒ,I_{render})

where [symbol] ₁ is a photometric loss (calculated based on a pixel-by-pixel difference between the training image and the generated image), and [symbol] _{D-SSIM} is a structural loss based on a structural similarity index measure (SSIM). Backpropagation may then be used to adjust the parameters of the Gaussian ellipsoids and the parameters of the rendering function (including, e.g., the matrix elements of k and q, in embodiments in which these functions are linear transformations), and, as mentioned above, Gaussian ellipsoids may be added or pruned.

In some embodiments, a multi-head variant of the attention function may be employed, for example, using, e.g., the following equation:

ξ(x)ᵢ=exp(β₁s₁(x)ᵢ+β₂s₂(x)ᵢ+ . . . +βₙsₙ(x)ᵢ)−1,ξ(x)∈[0,+∞]

where {β₁, β₂, . . . , βₙ} are learnable coefficients, and

$${{s}_{n} ( x )}_{i} = \frac{{φ ( {k}_{n} ( {θ}_{i} ) )}^{T} φ ( {q}_{n} ( {θ}_{x} ) )}{{\sum }_{{θ}_{j} ∈ Θ} {φ ( {k}_{n} ( {θ}_{j} ) )}^{T} φ ( {q}_{n} ( {θ}_{x} ) )} .$$

This may be simplified, using βᵢ=1, to

ξ(x)ᵢ=exp(s₁(x)ᵢ+s₂(x)ᵢ+ . . . +sₙ(x)ᵢ)−1,ξ(x)∈[0,eⁿ−1].

In such embodiments, multiple attention heads may independently compute attention values using different learnable transformations of the Gaussian feature vectors and the pixel feature vectors. Each attention head may apply separate transformation functions to the feature vectors prior to calculating similarity values and applying the attention function described above. The outputs of the multiple attention heads may then be combined, for example by summation, averaging, concatenation followed by a projection operation, or other aggregation techniques, to determine a final attention value that modulates the contribution of the Gaussian ellipsoid during rendering. Using multiple attention heads may enable the rendering system to capture different contextual relationships among Gaussian ellipsoids, such as spatial relationships, orientation relationships, or other feature interactions.

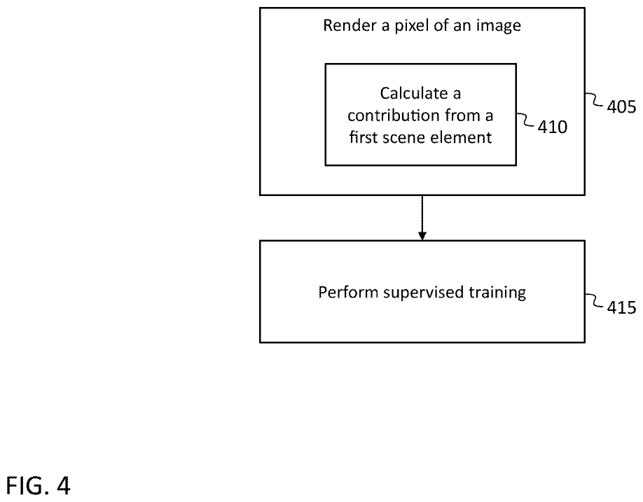

FIG. 4 shows a method of generating images, in some embodiments. Although FIG. 4 illustrates various operations in such a method, embodiments according to the present disclosure are not limited thereto. For example, according to some embodiments, such a method may include additional operations or fewer operations, or the order of operations may vary (unless otherwise explicitly stated or implied) without departing from the spirit and scope of embodiments according to the present disclosure.

In some embodiments, the method includes rendering, at 405, a pixel of an image corresponding to a camera pose. For example, a system for generating images based on a three-dimensional model may be used to generate images based on camera poses; the generation of each image may include rendering a plurality of pixels (e.g., all of the pixels of the image). The rendering may include: calculating, at 410, a contribution from a first scene element (e.g., the contribution being one of the terms of the sum of Equation 9, e.g., a contribution equal to Tᵢ(x)·σᵢ(x)·ξ(x)ᵢ·cᵢ), the contribution being based on: an opacity function σᵢ(x) of the first scene element, a color cᵢ of the first scene element, a transmittance (1−σⱼ(x)) of a second scene element (the transmittance being a factor of Tᵢ(x)), and a first attention coefficient ξ(x)ᵢ, the first attention coefficient being based on a first measure of similarity s(x)ᵢ, between attributes of the first scene element and attributes of the pixel.

In some embodiments, the first measure of similarity is normalized (as shown in Equation 6) such that a sum of the first measure of similarity and measures of similarity of a plurality of scene elements, not including the first scene element, is equal to a constant (e.g., equal to the constant value 1).

In some embodiments, the first measure of similarity is within 30% of a similarity function, the similarity function being proportional to a dot product (e.g., φ(k(θᵢ))^{T}φ(q(θₓ)) in Equation 6) of a first vector and a second vector, the first vector being based on the attributes θᵢ of the first scene element, and the second vector being based on the attributes θₓ of the pixel. For example, in some embodiments the function of Equation 6 is used to calculate the measure of similarity; in other embodiments a different but similar function (which produces a measure of similarity that (e.g., for at least two different Gaussian ellipsoids of the scene model) is within 30% of a function proportional to the function of Equation 6) is used.

In some embodiments, the first vector is equal to a kernel function evaluated on a product of a matrix and the attributes of the first scene element, the kernel function being a differentiable nonlinear monotonically increasing function that is bounded below. In some embodiments, the first measure of similarity is calculated based on a linear transformation of the attributes of the pixel. In some embodiments, the linear transformation maps a 9-dimensional vector including the attributes of the pixel to a vector having more than 9 dimensions. For example, the function φ(x) of Equation 6 may be the exponential linear unit function of Equation 7 (which is a differentiable nonlinear monotonically increasing function that is bounded below (e.g., its value is nowhere less than −α)), and which, as shown in Equation 6, may be evaluated (element-wise) on k(θᵢ), which may be a matrix product of (i) an m×9 (e.g., 16×9) matrix and (ii) the (9-dimensional) vector θᵢ.

In some embodiments, the first measure of similarity is calculated based on a linear transformation of the attributes of the first scene element. In some embodiments, the linear transformation maps a 9-dimensional vector including the attributes of the first scene element to a vector having more than 9 dimensions.

In some embodiments, the attributes of the first scene element include coordinates (e.g., θₓ, θ_{y}, θ_{z}, as shown in Equation 5) of the first scene element. In some embodiments, the attributes of the first scene element further include scale factors

$$( e . g . , \frac{{θ}_{sx}}{( {θ}_{sx} + {θ}_{sy} + {θ}_{sz} )} , \frac{{θ}_{sy}}{( {θ}_{sx} + {θ}_{sy} + {θ}_{sz} )} , \frac{{θ}_{sz}}{( {θ}_{sx} + {θ}_{sy} + {θ}_{sz} )} ,$$

as shown in Equation 5) for the first scene element. In some embodiments, the attributes of the first scene element further include a rotation (e.g., θᵣₒₗₗ, θ_{pitch}, θ_{yaw}, as shown in Equation 5) for the first scene element.

In some embodiments, the method further includes performing supervised training to determine the attributes of the first scene element.

In some embodiments: the first measure of similarity is calculated based on a linear transformation of the attributes of the first scene element, and the method further includes performing, at 415, supervised training to determine parameters of the linear transformation. For example, as mentioned above, supervised training may be performed using a plurality of labeled training images, each labeled with the camera pose at which it was taken. Each iteration of training may include (i) generating, using the system for image generation, a plurality of generated images, each corresponding to a respective training image (ii) calculating a loss function that is a measure of the discrepancies between the generated images and the training images, and (iii) adjusting, using backpropagation, the parameters of the system for image generation in a direction that reduces the loss function. In some embodiments, the training for generating the scene model (e.g., for determining the attributes of the first scene element) is performed concurrently with the training for determining the parameters of the linear transformations k and q.

In some embodiments, the attention coefficient may be determined using a learned transformation of the Gaussian attributes and a learned transformation of the pixel attributes, followed by a kernel function. The learned transformations may be implemented using linear projections, neural network layers, or other differentiable functions trained using supervised learning.

In some embodiments, the rendering operations described herein may be executed on parallel processing hardware such as a graphics processing unit (GPU), tensor processing unit (TPU), or other accelerator hardware. Tile-level rendering and attention calculations may be performed in parallel across multiple processing cores, allowing the system to render images for augmented reality, virtual reality, or gaming applications at interactive frame rates.

The described techniques according to embodiments of the present disclosure may enable relatively improved rendering quality while maintaining real-time rendering performance. By restricting attention calculations to subsets of Gaussian ellipsoids associated with a tile or region of the image plane and by employing computationally efficient attention formulations, the rendering process may be implemented efficiently on graphics processing units (GPUs) or other parallel processing hardware. Because the attention calculations are integrated directly into the rendering pipeline and executed on parallel processing hardware, the described techniques improve the operation of image rendering systems rather than merely performing an abstract mathematical calculation.

As mentioned above, in some embodiments the use of an attention coefficient in the rendering function may reduce or avoid imperfections in generated images, such as rendering inconsistencies, artifacts, and degraded image quality, which may be present if a rendering function lacking an attention coefficient is used. As such, the embodiments disclosed herein improve the technology of generating images, and, for example, the technology of generating an image corresponding to a new camera pose based on images previously taken from other camera poses, different from the new camara pose.

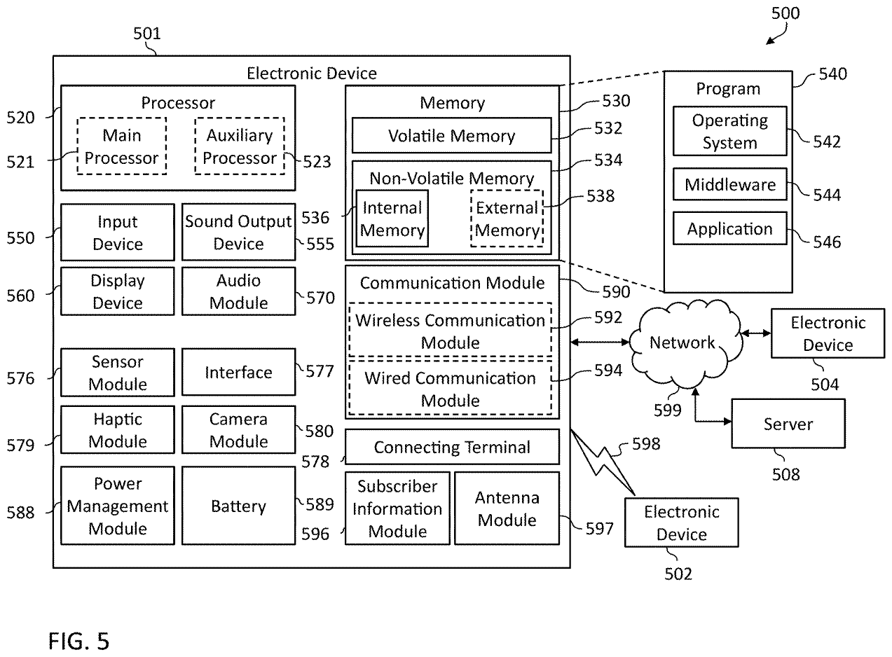

FIG. 5 is a block diagram of an electronic device (such as one of the processors of FIGS. 1B and 1C), in a network environment 500, according to an embodiment.

Referring to FIG. 5, an electronic device 501 in a network environment 500 may communicate with an electronic device 502 via a first network 598 (e.g., a short-range wireless communication network), or an electronic device 504 or a server 508 via a second network 599 (e.g., a long-range wireless communication network). The electronic device 501 may communicate with the electronic device 504 via the server 508. The electronic device 501 may include a processor 520, a memory 530, an input device 550, a sound output device 555, a display device 560, an audio module 570, a sensor module 576, an interface 577, a haptic module 579, a camera module 580, a power management module 588, a battery 589, a communication module 590, a subscriber identification module (SIM) card 596, or an antenna module 597. In one embodiment, at least one (e.g., the display device 560 or the camera module 580) of the components may be omitted from the electronic device 501, or one or more other components may be added to the electronic device 501. Some of the components may be implemented as a single integrated circuit (IC). For example, the sensor module 576 (e.g., a fingerprint sensor, an iris sensor, or an illuminance sensor) may be embedded in the display device 560 (e.g., a display).

The processor 520 may execute software (e.g., a program 540) to control at least one other component (e.g., a hardware or a software component) of the electronic device 501 coupled with the processor 520 and may perform various data processing or computations.

As at least part of the data processing or computations, the processor 520 may load a command or data received from another component (e.g., the sensor module 576 or the communication module 590) in volatile memory 532, process the command or the data stored in the volatile memory 532, and store resulting data in non-volatile memory 534. The processor 520 may include a main processor 521 (e.g., a central processing unit (CPU) or an application processor (AP)), and an auxiliary processor 523 (e.g., a graphics processing unit (GPU), an image signal processor (ISP), a sensor hub processor, or a communication processor (CP)) that is operable independently from, or in conjunction with, the main processor 521. Additionally or alternatively, the auxiliary processor 523 may be adapted to consume less power than the main processor 521, or execute a particular function. The auxiliary processor 523 may be implemented as being separate from, or a part of, the main processor 521.

The auxiliary processor 523 may control at least some of the functions or states related to at least one component (e.g., the display device 560, the sensor module 576, or the communication module 590) among the components of the electronic device 501, instead of the main processor 521 while the main processor 521 is in an inactive (e.g., sleep) state, or together with the main processor 521 while the main processor 521 is in an active state (e.g., executing an application). The auxiliary processor 523 (e.g., an image signal processor or a communication processor) may be implemented as part of another component (e.g., the camera module 580 or the communication module 590) functionally related to the auxiliary processor 523.

The memory 530 may store various data used by at least one component (e.g., the processor 520 or the sensor module 576) of the electronic device 501. The various data may include, for example, software (e.g., the program 540) and input data or output data for a command related thereto. The memory 530 may include the volatile memory 532 or the non-volatile memory 534. Non-volatile memory 534 may include internal memory 536 and/or external memory 538.

The program 540 may be stored in the memory 530 as software, and may include, for example, an operating system (OS) 542, middleware 544, or an application 546.

The input device 550 may receive a command or data to be used by another component (e.g., the processor 520) of the electronic device 501, from the outside (e.g., a user) of the electronic device 501. The input device 550 may include, for example, a microphone, a mouse, or a keyboard.

The sound output device 555 may output sound signals to the outside of the electronic device 501. The sound output device 555 may include, for example, a speaker or a receiver. The speaker may be used for general purposes, such as playing multimedia or recording, and the receiver may be used for receiving an incoming call. The receiver may be implemented as being separate from, or a part of, the speaker.

The display device 560 may visually provide information to the outside (e.g., a user) of the electronic device 501. The display device 560 may include, for example, a display, a hologram device, or a projector and control circuitry to control a corresponding one of the display, hologram device, and projector. The display device 560 may include touch circuitry adapted to detect a touch, or sensor circuitry (e.g., a pressure sensor) adapted to measure the intensity of force incurred by the touch.

The audio module 570 may convert a sound into an electrical signal and vice versa. The audio module 570 may obtain the sound via the input device 550 or output the sound via the sound output device 555 or a headphone of an external electronic device 502 directly (e.g., wired) or wirelessly coupled with the electronic device 501.

The sensor module 576 may detect an operational state (e.g., power or temperature) of the electronic device 501 or an environmental state (e.g., a state of a user) external to the electronic device 501, and then generate an electrical signal or data value corresponding to the detected state. The sensor module 576 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 577 may support one or more specified protocols to be used for the electronic device 501 to be coupled with the external electronic device 502 directly (e.g., wired) or wirelessly. The interface 577 may include, for example, a high-definition multimedia interface (HDMI), a universal serial bus (USB) interface, a secure digital (SD) card interface, or an audio interface.

A connecting terminal 578 may include a connector via which the electronic device 501 may be physically connected with the external electronic device 502. The connecting terminal 578 may include, for example, an HDMI connector, a USB connector, an SD card connector, or an audio connector (e.g., a headphone connector).

The haptic module 579 may convert an electrical signal into a mechanical stimulus (e.g., a vibration or a movement) or an electrical stimulus which may be recognized by a user via tactile sensation or kinesthetic sensation. The haptic module 579 may include, for example, a motor, a piezoelectric element, or an electrical stimulator.

The camera module 580 may capture a still image or moving images. The camera module 580 may include one or more lenses, image sensors, image signal processors, or flashes. The power management module 588 may manage power supplied to the electronic device 501. The power management module 588 may be implemented as at least part of, for example, a power management integrated circuit (PMIC).

The battery 589 may supply power to at least one component of the electronic device 501. The battery 589 may include, for example, a primary cell which is not rechargeable, a secondary cell which is rechargeable, or a fuel cell.

The communication module 590 may support establishing a direct (e.g., wired) communication channel or a wireless communication channel between the electronic device 501 and the external electronic device (e.g., the electronic device 502, the electronic device 504, or the server 508) and performing communication via the established communication channel. The communication module 590 may include one or more communication processors that are operable independently from the processor 520 (e.g., the AP) and supports a direct (e.g., wired) communication or a wireless communication. The communication module 590 may include a wireless communication module 592 (e.g., a cellular communication module, a short-range wireless communication module, or a global navigation satellite system (GNSS) communication module) or a wired communication module 594 (e.g., a local area network (LAN) communication module or a power line communication (PLC) module). A corresponding one of these communication modules may communicate with the external electronic device via the first network 598 (e.g., a short-range communication network, such as BLUETOOTH™, wireless-fidelity (Wi-Fi) direct, or a standard of the Infrared Data Association (IrDA)) or the second network 599 (e.g., a long-range communication network, such as a cellular network, the Internet, or a computer network (e.g., LAN or wide area network (WAN)). These various types of communication modules may be implemented as a single component (e.g., a single IC), or may be implemented as multiple components (e.g., multiple ICs) that are separate from each other. The wireless communication module 592 may identify and authenticate the electronic device 501 in a communication network, such as the first network 598 or the second network 599, using subscriber information (e.g., international mobile subscriber identity (IMSI)) stored in the subscriber identification module 596.

The antenna module 597 may transmit or receive a signal or power to or from the outside (e.g., the external electronic device) of the electronic device 501. The antenna module 597 may include one or more antennas, and, therefrom, at least one antenna appropriate for a communication scheme used in the communication network, such as the first network 598 or the second network 599, may be selected, for example, by the communication module 590 (e.g., the wireless communication module 592). The signal or the power may then be transmitted or received between the communication module 590 and the external electronic device via the selected at least one antenna.

Commands or data may be transmitted or received between the electronic device 501 and the external electronic device 504 via the server 508 coupled with the second network 599. Each of the electronic devices 502 and 504 may be a device of a same type as, or a different type, from the electronic device 501. All or some of operations to be executed at the electronic device 501 may be executed at one or more of the external electronic devices 502, 504, or 508. For example, if the electronic device 501 should perform a function or a service automatically, or in response to a request from a user or another device, the electronic device 501, instead of, or in addition to, executing the function or the service, may request the one or more external electronic devices to perform at least part of the function or the service. The one or more external electronic devices receiving the request may perform the at least part of the function or the service requested, or an additional function or an additional service related to the request and transfer an outcome of the performing to the electronic device 501. The electronic device 501 may provide the outcome, with or without further processing of the outcome, as at least part of a reply to the request. To that end, a cloud computing, distributed computing, or client-server computing technology may be used, for example.

Embodiments of the subject matter and the operations described in this specification may be implemented in digital electronic circuitry, or in computer software, firmware, or hardware, including the structures disclosed in this specification and their structural equivalents, or in combinations of one or more of them. Embodiments of the subject matter described in this specification may be implemented as one or more computer programs, i.e., one or more modules of computer-program instructions, encoded on computer-storage medium for execution by, or to control the operation of data-processing apparatus. Alternatively or additionally, the program instructions can be encoded on an artificially generated propagated signal, e.g., a machine-generated electrical, optical, or electromagnetic signal, which is generated to encode information for transmission to suitable receiver apparatus for execution by a data processing apparatus. A computer-storage medium can be, or be included in, a computer-readable storage device, a computer-readable storage substrate, a random or serial-access memory array or device, or a combination thereof. Moreover, while a computer-storage medium is not a propagated signal, a computer-storage medium may be a source or destination of computer-program instructions encoded in an artificially generated propagated signal. The computer-storage medium can also be, or be included in, one or more separate physical components or media (e.g., multiple CDs, disks, or other storage devices). Additionally, the operations described in this specification may be implemented as operations performed by a data-processing apparatus on data stored on one or more computer-readable storage devices or received from other sources.

While this specification may contain many specific implementation details, the implementation details should not be construed as limitations on the scope of any claimed subject matter, but rather be construed as descriptions of features specific to particular embodiments. Certain features that are described in this specification in the context of separate embodiments may also be implemented in combination in a single embodiment. Conversely, various features that are described in the context of a single embodiment may also be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described herein. Other embodiments are within the scope of the following claims. In some cases, the actions set forth in the claims may be performed in a different order and still achieve desirable results. Additionally, the processes depicted in the accompanying figures do not necessarily require the particular order shown, or sequential order, to achieve desirable results. In certain implementations, multitasking and parallel processing may be advantageous.

As will be recognized by those skilled in the art, the innovative concepts described herein may be modified and varied over a wide range of applications. Accordingly, the scope of claimed subject matter should not be limited to any of the specific exemplary teachings discussed above, but is instead defined by the following claims.

What is claimed is:

1. A method, comprising:
rendering a pixel of an image corresponding to a camera pose, the rendering comprising:
calculating a contribution from a first scene element, the contribution being based on:
an opacity function of the first scene element;
a color of the first scene element;
a transmittance of a second scene element; and
a first attention coefficient,
the first attention coefficient being based on a first measure of similarity between attributes of the first scene element and attributes of the pixel.

2. The method of claim 1, wherein the first measure of similarity is normalized such that a sum of the first measure of similarity and measures of similarity of a plurality of scene elements, not including the first scene element, is equal to a constant.

3. The method of claim 1, wherein the first measure of similarity is within 30% of a similarity function, the similarity function being proportional to a dot product of a first vector and a second vector, the first vector being based on the attributes of the first scene element, and the second vector being based on the attributes of the pixel.

4. The method of claim 3, wherein the first vector is equal to a kernel function evaluated on a product of a matrix and the attributes of the first scene element, the kernel function being a differentiable nonlinear monotonically increasing function that is bounded below.

5. The method of claim 1, wherein the first measure of similarity is calculated based on a linear transformation of the attributes of the pixel.

6. The method of claim 5, wherein the linear transformation maps a 9-dimensional vector comprising the attributes of the pixel to a vector having more than 9 dimensions.

7. The method of claim 1, wherein the first measure of similarity is calculated based on a linear transformation of the attributes of the first scene element.

8. The method of claim 7, wherein the linear transformation maps a 9-dimensional vector comprising the attributes of the first scene element to a vector having more than 9 dimensions.

9. The method of claim 1, wherein the attributes of the first scene element include coordinates of the first scene element.

10. The method of claim 9, wherein the attributes of the first scene element further include scale factors for the first scene element.

11. The method of claim 10, wherein the attributes of the first scene element further include a rotation for the first scene element.

12. The method of claim 1, further including performing supervised training to determine the attributes of the first scene element.

13. The method of claim 1, wherein:
the first measure of similarity is calculated based on a linear transformation of the attributes of the first scene element, and
the method further comprises performing supervised training to determine parameters of the linear transformation.

14. A system comprising:
one or more processors; and
a memory storing instructions which, when executed by the one or more processors, cause performance of:
rendering a pixel of an image corresponding to a camera pose, the rendering comprising:
calculating a contribution from a first scene element, the contribution being based on:
an opacity function of the first scene element;
a color of the first scene element;
a transmittance of a second scene element; and
a first attention coefficient,
the first attention coefficient being based on a first measure of similarity between attributes of the first scene element and attributes of the pixel.

15. The system of claim 14, wherein the first measure of similarity is normalized such that a sum of the first measure of similarity and measures of similarity of a plurality of scene elements, not including the first scene element, is equal to a constant.

16. The system of claim 14, wherein the first measure of similarity is within 30% of a similarity function, the similarity function being proportional to a dot product of a first vector and a second vector, the first vector being based on the attributes of the first scene element, and the second vector being based on the attributes of the pixel.

17. The system of claim 16, wherein the first vector is equal to a kernel function evaluated on a product of a matrix and the attributes of the first scene element, the kernel function being a differentiable nonlinear monotonically increasing function that is bounded below.

18. The system of claim 14, wherein the first measure of similarity is calculated based on a linear transformation of the attributes of the pixel.

19. The system of claim 18, wherein the linear transformation maps a 9-dimensional vector comprising the attributes of the pixel to a vector having more than 9 dimensions.

20. A system comprising:
means for processing; and
a memory storing instructions which, when executed by the means for processing, cause performance of:
rendering a pixel of an image corresponding to a camera pose, the rendering comprising:
calculating a contribution from a first scene element, the contribution being based on:
an opacity function of the first scene element;
a color of the first scene element;
a transmittance of a second scene element; and
a first attention coefficient,
the first attention coefficient being based on a first measure of similarity between attributes of the first scene element and attributes of the pixel.
